(19) United States
(12) Patent Application Publication
(10) Pub. No.: US 2015/0022679 A1
(43) Pub. Date: Jan. 22, 2015

(54) Fast Motion Detection with GPU

(71) Applicant: Motorola Mobility LLC, Libertyville, IL (US)

(72) Inventors: Denis S. Shchepetov, Grayslake, IL (US); Eric F. Aas, Windsor, CO (US)

(73) Assignee: Motorola Mobility LLC, Libertyville, IL (US)

(21) Appl. No.: 14/031,244

(22) Filed: Sep. 19, 2013

Related U.S. Application Data
(60) Provisional application No. 61/846,680, filed on Jul. 16, 2013.

(51) Int. Cl. G03B 13/36; H04N 5/232

(52) U.S. Cl. CPC G03B 13/36; H04N 5/23212
USPC 348/208.12

(57) ABSTRACT

Disclosed are systems and methods for determining when to focus a digital camera to capture a scene. A current frame and a prior frame are differenced to determine a frame difference. The current frame is also differenced with a jittered version of the current frame to produce a jitter difference. If the frame difference exceeds the jitter difference, the scene is deemed to have moved and the camera is autofocused, and otherwise the camera focus is not altered.

### CROSS-REFERENCE TO RELATED APPLICATION(S)

The present disclosure is a non-provisional application of co-pending and commonly assigned U.S. Provisional Application No. 61/846,680, filed on 16 Jul. 2013, from which benefits under 35 USC 119 are hereby claimed and the contents of which are incorporated herein by reference.

### TECHNICAL FIELD

The present disclosure is related generally to digital camera focusing and, more particularly, to a system and method for sensing scene movement to initiate focusing of a camera.

### BACKGROUND

The introduction of the consumer-level film camera changed the way we saw our world, mesmerizing the public with life-like images and opening up an era of increasingly visual information. However, as imaging technologies continued to improve, the advent of inexpensive digital cameras would eventually render traditional film cameras obsolete, along with the sepia tones and grainy pictures of yesteryear. However, the digital camera offered the one thing that had eluded the film camera—spontaneity and instant gratification. Pictures could be taken, erased, saved, instantly viewed or printed and otherwise utilized without delay.

The quality of digital image technology has now improved to the point that very few users miss the film camera. Indeed, most cell phones, smart phones, tablets, and other portable electronic devices include a built-in digital camera. Nonetheless, despite the unquestioned dominance of digital imaging today, one requirement remains unchanged from the days of yore: the requirement to focus the camera. Today's digital cameras often provide an autofocus function that automatically places a scene in focus. However, when the scene suddenly changes, the autofocus function must collect enough frames of data to refocus the scene. This results in a delay of 300 ms or more while the autofocus function waits for the scene to stabilize, resulting in a poor user experience in dynamic environments.

It will be appreciated that this Background section represents the observations of the inventors, which are provided simply as a research guide to the reader. As such, nothing in this Background section is intended to represent, or to fully describe, prior art.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a logical diagram of a mobile user device within which embodiments of the disclosed principles may be implemented;

FIG. 2 is a schematic diagram of a movement analysis system;

FIG. 3 is a schematic diagram of a movement analysis system in accordance with an embodiment of the disclosed principles;

FIG. 4 is a schematic diagram of a jitter simulator in accordance with an embodiment of the disclosed principles;

FIG. 5A is a simplified drawing of a scene with respect to which the disclosed principles may be implemented;

FIG. 5B is a simplified drawing of a jitter difference of the scene of FIG. 5A in accordance with an embodiment of the disclosure;

FIG. 6A is a simplified drawing of a further scene with respect to which the disclosed principles may be implemented;

FIG. 6B is a simplified drawing of a jitter difference of the scene of FIG. 6A in accordance with an embodiment of the disclosure; and

FIG. 7 is a flow chart of a process for detecting movement of a scene in accordance with an embodiment of the disclosure.

### DETAILED DESCRIPTION

Turning to the drawings, wherein like reference numerals refer to like elements, techniques of the present disclosure are illustrated as being implemented in a suitable environment. The following description is based on embodiments of the disclosed principles and should not be taken as limiting the claims with regard to alternative embodiments that are not explicitly described herein.

Before providing a detailed discussion of the figures, a brief overview will be given to guide the reader. In the disclosed examples, only a single frame is needed to detect scene movement and to start the autofocus routine, meaning that the delay until the initiation of focusing, when needed, is only 60 ms rather than the traditional 300 ms. In this regard, the disclosed examples process each frame using a graphics processing unit (GPU) of the device to accelerate the focus decision and improve the preview and video experience. This can be viewed colloquially as a continuous rather than intermittent auto-focus function. A GPU is a specialized chip, board or module that is designed specifically for efficient manipulation of computer graphics. In particular, a GPU embodies a more parallel structure than general-purpose CPUs, allowing more efficient processing of large blocks of data.

In an embodiment, the GPU calculates a pixel-based frame difference and estimates scene complexity at a camera frame rate to detect scene stability in real time (at each new frame). In addition to providing a speed advantage over CPU-based systems that wait for multiple frames, this also provides a lower complexity than techniques that rely on per-block motion vectors estimated during compression, e.g., techniques used in video processing.

At a basic level, certain of the disclosed embodiments simulate image jitter to derive a frame-specific threshold level for judging an inter-frame difference (from the previous frame to the current frame). In this way, more highly detailed scenes may experience a higher movement threshold and thus the system will provide a similar rapid auto focus response for both high detail and low detail scenes.

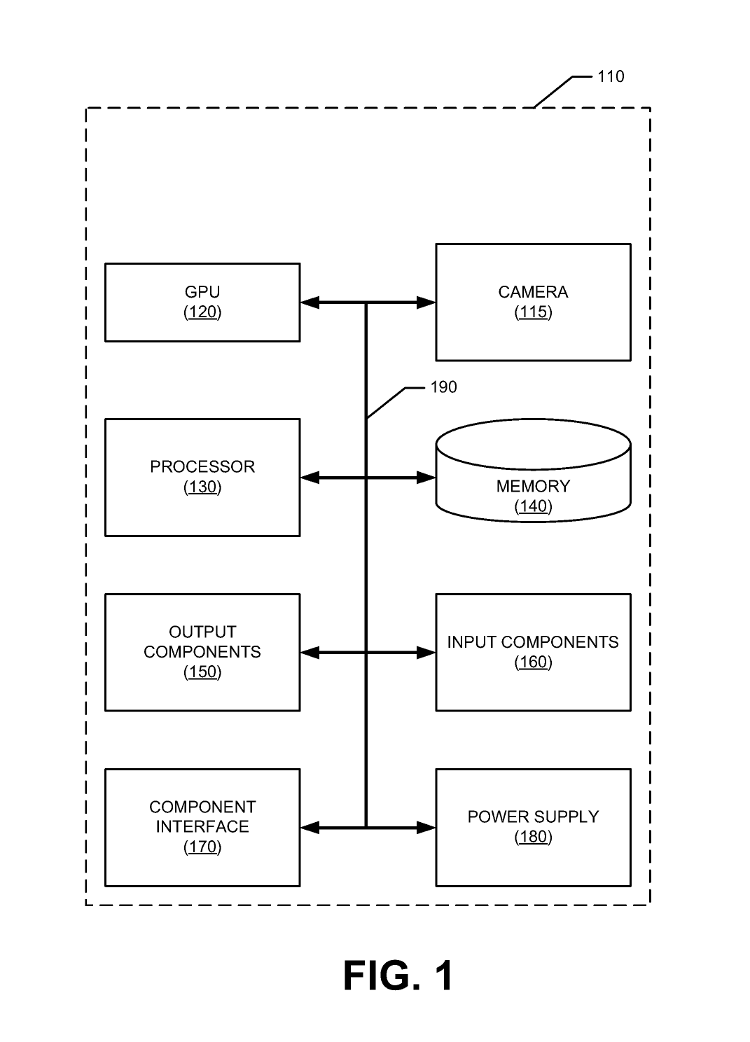

Turning now to a more detailed discussion in conjunction with the attached figures, the schematic diagram of FIG. 1 shows an exemplary device within which aspects of the present disclosure may be implemented. In particular, the schematic diagram illustrates a user device 110 including several exemplary internal components. Internal components of the user device 110 may include a camera 115, a GPU 120, a processor 130, a memory 140, one or more output components 150, and one or more input components 160.

The processor 130 can be any of a microprocessor, microcomputer, application-specific integrated circuit, or the like. For example, the processor 130 can be implemented by one or more microprocessors or controllers from any desired family or manufacturer. Similarly, the memory 140 may reside on the same integrated circuit as the processor 130. Additionally or alternatively, the memory 140 may be accessed via a network, e.g., via cloud-based storage. The memory 140 may include a random access memory (i.e., Synchronous Dynamic Random Access Memory (SDRAM), Dynamic Random Access Memory (DRAM), RAMBUS Dynamic Random Access Memory (RDRM) and/or any other type of random access memory device). Additionally or alternatively, the memory 140 may include a read only memory (i.e., a hard drive, flash memory and/or any other desired type of memory device).

The information that is stored by the memory 140 can include code associated with one or more operating systems and/or applications as well as informational data, e.g., program parameters, process data, etc. The operating system and applications are typically implemented via executable instructions stored in a non-transitory computer readable medium (e.g., memory 140) to control basic functions of the electronic device 110. Such functions may include, for example, interaction among various internal components, control of the camera 120 and/or the component interface 170, and storage and retrieval of applications and data to and from the memory 140.

The device 110 may also include a component interface 170 to provide a direct connection to auxiliary components or accessories and a power supply 180, such as a battery, for providing power to the device components. In an embodiment, all or some of the internal components communicate with one another by way of one or more internal communication links 190, such as an internal bus.

Further with respect to the applications, these typically utilize the operating system to provide more specific functionality, such as file system service and handling of protected and unprotected data stored in the memory 140. Although many applications may govern standard or required functionality of the user device 110, in many cases applications govern optional or specialized functionality, which can be provided, in some cases, by third party vendors unrelated to the device manufacturer.

Finally, with respect to informational data, e.g., program parameters and process data, this non-executable information can be referenced, manipulated, or written by the operating system or an application. Such informational data can include, for example, data that is preprogrammed into the device during manufacture, data that is created by the device, or any of a variety of types of information that is uploaded to, downloaded from, or otherwise accessed at servers or other devices with which the device is in communication during its ongoing operation.

In an embodiment, the device 110 is programmed such that the processor 130 and memory 140 interact with the other components of the device to perform a variety of functions. The processor 130 may include or implement various modules and execute programs for initiating different activities such as launching an application, transferring data, and toggling through various graphical user interface objects (e.g., toggling through various icons that are linked to executable applications).

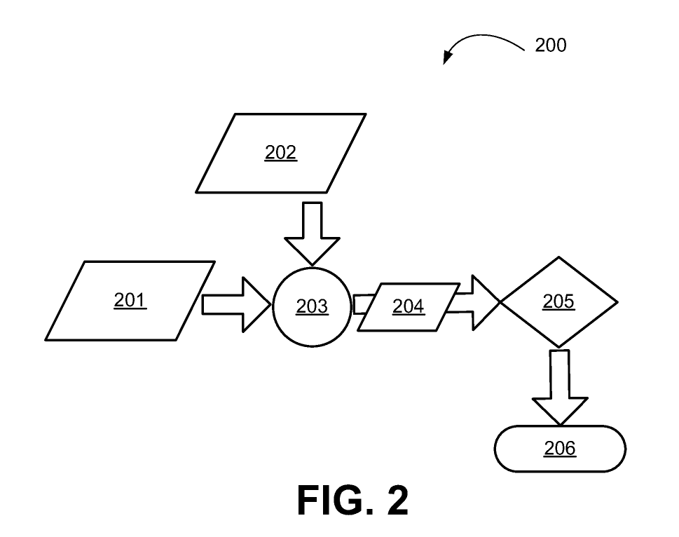

Within the context of prior autofocus systems, FIG. 2 illustrates a prior mechanism for making autofocus decisions during operation of a camera such as camera 115. In the illustrated example 200, which is simplified for purposes of easier explanation, the camera controller captures several frames. After each capture, the camera controller differences the sharpness of current frame 201 and the sharpness of the prior frame 202 in a differencer 203, and compares, at comparator 205, the resultant difference 204 to a threshold noise level in order to produce an autofocus decision 206. In particular, when the difference 204 is below the noise threshold for multiple frames, the controller identifies possible movement in the scene, and accordingly refocuses the scene. With frames occurring on a 60 ms interval, the delay incurred by this system is typically on the order of 300 ms, e.g., five frames.

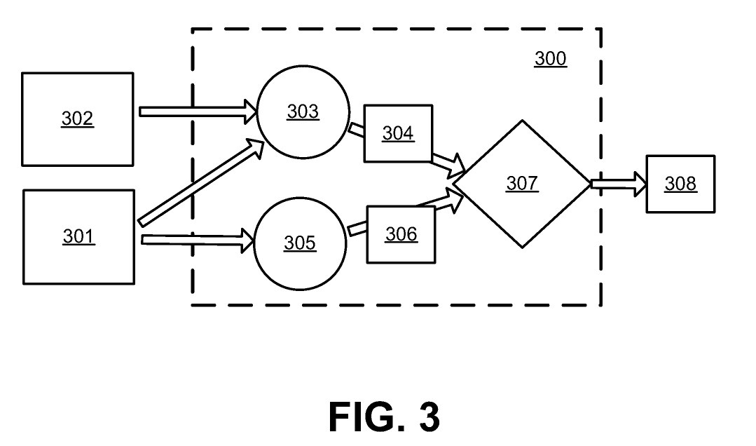

An improved decision architecture in keeping with the disclosed principles is shown in FIG. 3. In particular, the focus decision architecture 300 shown in the schematic architecture view of FIG. 3 receives as input a current frame 301 and a previous frame 302. The current frame 301 and the previous frame 302 are input to a differencer 303. The differencer 303 provides a difference signal 304 based on the resultant difference between the current frame 301 and the previous frame 302.

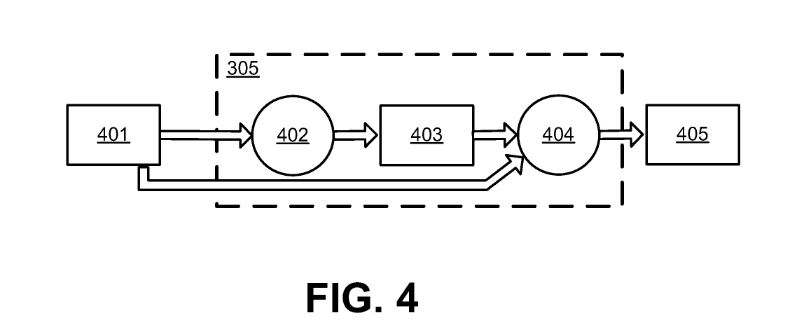

Meanwhile, the current frame 301 is also provided as input to a jitter simulator 305, which outputs a jitter difference 306. The operation of the jitter simulator 305 will be described in greater detail below in reference to FIG. 4. However, continuing with FIG. 3 for the moment, the jitter difference 306 is provided as a reference value to a comparator 307. The difference signal 304 is also provided to the comparator 307 as an operand. The comparator 307 then compares the input difference signal 304 to the reference value (jitter difference 306) and outputs an autofocus decision value 308. In an embodiment, if the input difference signal 304 is greater than the jitter difference 306, the autofocus decision value 308 is positive, that is, refocusing is requested. Otherwise, a subsequent frame is captured and the current frame 301 becomes a previous frame to be input into the focus decision architecture 300 to evaluate the new current frame.

As noted above, the jitter simulator 305 produces a jitter difference 306 for use in evaluating the current frame 301. In an embodiment, the jitter simulator 305 processes the current frame 301 to simulate or predict the effect of jitter. An exemplary jitter simulator 305 is shown schematically in FIG. 4. The jitter simulator 305 in this embodiment operates only on the current frame 401. In particular, the current frame is received as input into a shifter 402 which shifts the pixels in the frame 401 by a predetermined amount and in a predetermined direction. While any amount and direction may be chosen, it has been found that a beneficial shift amount is about 5 pixels, and a beneficial shift direction is diagonally. Thus, for example, the shifter 402 may shift the pixels of the current frame 401 to the right and upward by 5 pixels to yield a diagonally shifted array 403.

No particular treatment of the pixel locations vacated by the shift is required, and the pixel values pushed out of frame by the shift may also be ignored. However, in an alternative embodiment, each vacated pixel location is populated by a copy of the pixel value that was shifted across it. In the context of the above example, this results in a smearing or copying of a portion of the frame left side values and a portion of the frame bottom values. Alternatively, the frame 401 may be looped, with the pixel values that are pushed out-of-frame being reintroduced in the opposite side or corner of the frame to populate the vacated pixel locations.

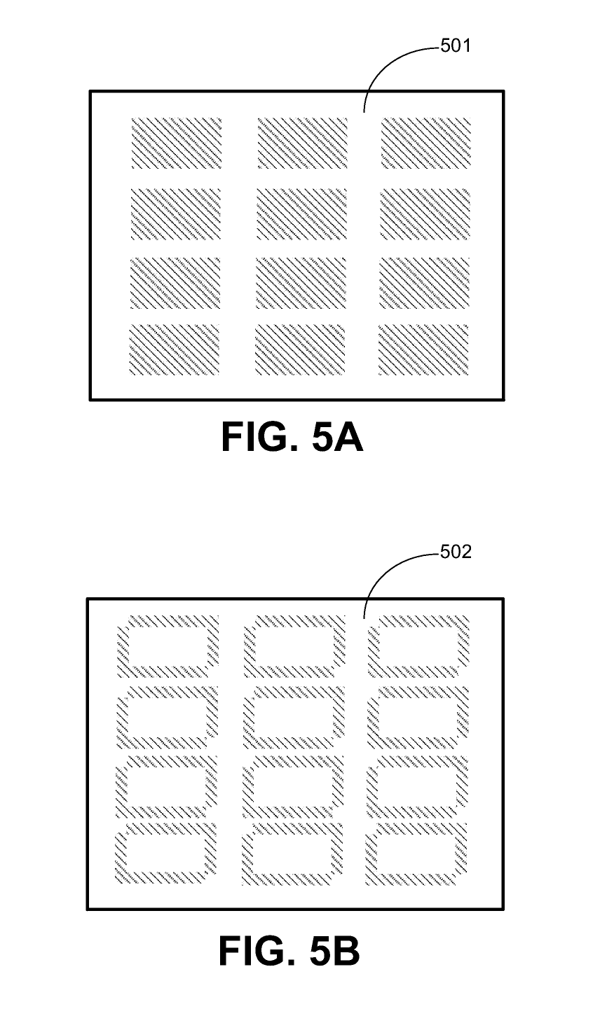

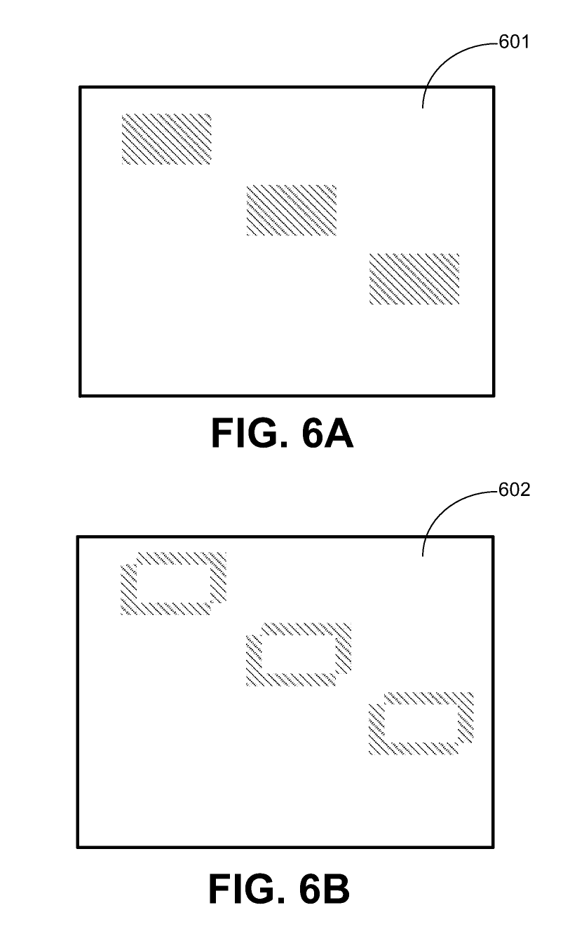

The diagonally shifted array 403 is then differenced at comparator 404 to produce a jitter difference 405, which is then provided to the comparator 307. The jitter difference 306, 405 provides a predictive measure regarding the likely results of scene movement without actually requiring scene movement. Thus, for example, a scene with many details and clean edges will result in a higher value jitter difference than will a scene with fewer details and clean edges. This effect can be seen in principle in FIGS. 5A, 5B, 6A and 6B. Referring to FIG. 5A, this figure shows a scene 501 having a large number of clean edges and details based on the presence of twelve fairly sharp rectangles. In an actual scene, these might be cars in a parking lot, boxes on shelves, blocks in a glass wall, and so on. FIG. 5B represents the effect of shifting the scene 501 slightly rightward and upward to yield a diagonal shift, and then differencing the original scene 501 and the shifted scene 501 to yield a jitter difference 502.

In an embodiment, mean pixel value is the measure of merit for each frame. In this embodiment, a jitter score is calculated as the mean pixel value of the current frame minus the previous frame, minus the mean pixel value of the jitter difference 502. As can be seen, the jitter difference 502 is significantly populated due to the movement of the many clean edges, which will lead to a high jitter score.

FIGS. 6A and 6B represent a scene and its jitter difference for a less detailed scene. In particular, the original scene 601 has few clean edges or details, being populated by only three clean-edged rectangles. The result of jittering the original scene and differencing the result with the original scene is shown in FIG. 6B. As can be seen, the resultant jitter difference 602 is far less populated than the resultant jitter difference 502 of the much more complicated scene 501 of FIG. 5A, leading to a lower jitter score.

In a sense, the jitter difference and jitter score can be seen as a prediction of how much effect a small scene movement would have on the inter-frame difference. By traditional measures, a small movement in a complicated scene would register as a larger movement than the same small movement in a less complicated scene. In traditional systems, this results in constant refocusing on complicated scenes and an inability to settle or stabilize focus in such environments. Conversely, the same traditional systems may underestimate the amount of movement in simpler scenes, leading to a failure to refocus when focusing is otherwise needed.

Against this backdrop, the disclosed principles provide a scene-specific reference against which to measure the significance of observed movement between a first frame and a second frame. In other words, the movement threshold for complex scenes will be greater than the movement threshold for less complicated scenes. This allows the autofocus function to provide the same experience regardless of whether the scene is high contrast or low contrast.

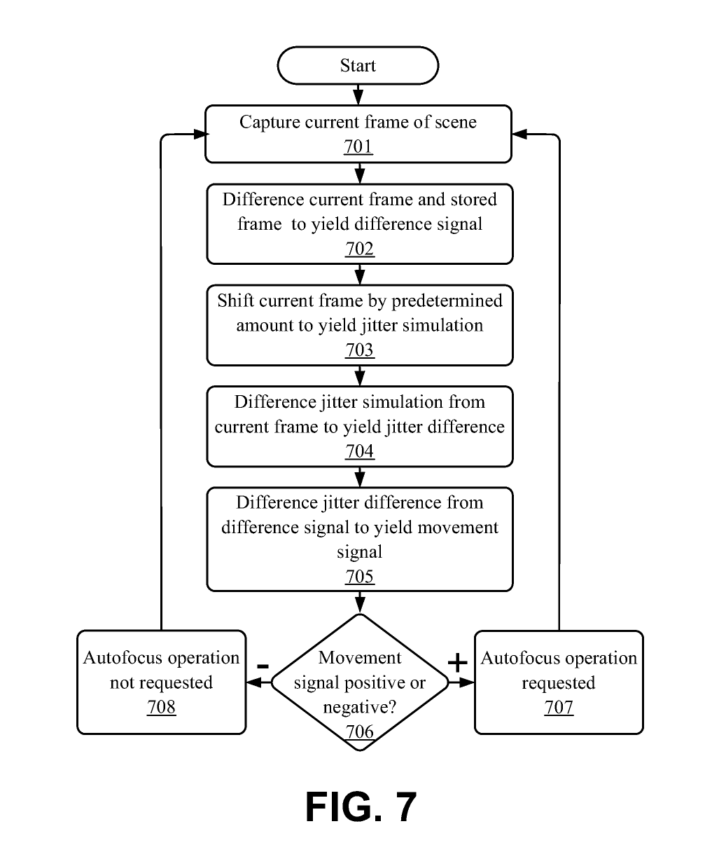

While the disclosed principles may be applied in a variety of ways, an exemplary decision process 700 is shown in the flowchart of FIG. 7. Although this example assumes an architecture that is similar to that shown herein, those of skill in the art will appreciate that changes in the architecture and corresponding changes in the process flow may be made without departing from the disclosed principles.

At stage 701 of the process 700, a current frame corresponding to a scene is captured, e.g., by the camera 115, it being understood that a prior frame corresponding essentially to the same scene has been previously stored during a prior iteration of the process 700. The current frame is differenced with the stored prior frame at stage 702 to yield a difference signal (e.g., difference signal 304).

The current frame is also shifted by a predetermined amount, e.g., a predetermined number of pixels, in a predetermined direction at stage 703 to produce a jitter simulation. It will be appreciated that the exact direction and exact amount of the shift are not critical. Moreover, although the shift is predetermined, there may be multiple such predetermined shifts that vary in direction and amount. For example, of three predetermined shifts, the shifts may be applied randomly, cyclically, or otherwise.

At stage 704, the jittered simulation is differenced from the current frame to provide a jitter difference, which is in turn differenced at stage 705 from the difference signal to produce a movement signal. If the difference signal exceeds the jitter difference, then the movement signal is positive, whereas if the jitter difference exceeds the difference signal then the movement signal is negative. At stage 706, it is determined whether the movement signal is positive or negative. If it is determined at stage 706 that the movement signal is positive, then an autofocus operation is requested at stage 707, while if the movement signal is negative, then the process flows to stage 708 and an autofocus operation is not requested. From either of stages 707 and 708, the process 700 returns to stage 701.

In an embodiment, the magnitude of the positive movement signal is further used to determine auto focus behavior at finer granularity than a simple binary decision. In particular, in this embodiment, if the movement signal is positive and relatively small, then a small focus adjustment is attempted. Conversely, if the signal is positive and relatively large, then a larger focus adjustment may be attempted.

In this way, small focus adjustments, e.g., using a continuous auto-focus algorithm, may be used to provide a better user experience when possible without causing slow focus adjustment when large adjustments are needed. Similarly, larger focus adjustments, e.g., using an exhaustive auto-focus algorithm, may speed the focusing task when needed, e.g., to focus from a close object to a distant object. By making a calculated decision on when small or large adjustments are needed the system can deliver an improved user experience and better focus performance.

It will be appreciated that the disclosed principles provide a means, though not a requirement, for improving camera autofocus response and stability. However, in view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for making an autofocus decision for a digital camera, the method comprising:
capturing a first frame of a scene and a second frame of the scene with the camera, the second frame being later in time than the first;
differencing the second frame and the first frame to yield a frame difference;
shifting the second frame by a predetermined amount in a predetermined direction to produce a jittered frame, and differencing the jittered frame from the second frame to produce a jitter difference; and
comparing the frame difference to the jitter difference to determine if movement has occurred in the scene between the first and second frames and making an autofocus decision based on whether movement has occurred.

2. The method for making an autofocus decision in accordance with claim 1, wherein the first frame and the second frame are temporally sequential frames.

3. The method for making an autofocus decision in accordance with claim 1, wherein shifting the second frame by a predetermined amount comprises shifting the second frame by about 5 pixels.

4. The method for making an autofocus decision in accordance with claim 1, wherein shifting the second frame in a predetermined direction comprises shifting the second frame diagonally.

5. The method for making an autofocus decision in accordance with claim 1, wherein comparing the frame difference to the jitter difference to determine if movement has occurred in the scene between the first and second frames comprises generating a movement signal representing the difference between the frame difference and the jitter difference, wherein the movement signal is positive if the frame difference is greater than the jitter difference and is negative if the frame difference is less than the jitter difference.

6. The method for making an autofocus decision in accordance with claim 5, wherein making an autofocus decision based on whether movement has occurred comprises requesting autofocus if the movement signal is positive.

7. The method for making an autofocus decision in accordance with claim 6, wherein making an autofocus decision based on whether movement has occurred further comprises requesting a type of autofocus algorithm based on a magnitude of the movement signal.

8. A method of focusing a digital camera on a scene, the method comprising:
capturing a current frame of the scene;
setting a movement threshold for the scene based on the features of the scene in the current frame;
comparing the current frame to a prior frame of the scene to determine if the current frame differs from the prior frame by more than the movement threshold; and
making a decision to focus the scene based on the comparison.

9. The method of focusing a digital camera on a scene in accordance with claim 8, wherein the current frame and the prior frame are sequential frames.

10. The method of focusing a digital camera on a scene in accordance with claim 8, wherein setting the movement threshold for the scene based on the features of the scene in the current frame further comprises:
shifting the current frame by a predetermined amount in a predetermined direction to produce a jitter frame and differencing the jitter frame and the current frame to produce the movement threshold.

11. The method of focusing a digital camera on a scene in accordance with claim 10, wherein shifting the current frame by a predetermined amount comprises shifting the current frame by a predetermined number of pixels.

12. The method of focusing a digital camera on a scene in accordance with claim 10, wherein shifting the current frame in a predetermined direction comprises shifting the current frame diagonally.

13. The method of focusing a digital camera on a scene in accordance with claim 10, wherein making a decision to focus the scene based on the comparison comprises deciding to focus the camera if the current frame differs from the prior frame by more than the movement threshold.

14. The method of focusing a digital camera on a scene in accordance with claim 10, wherein making a decision to focus the scene based on the comparison comprises deciding to not focus the camera if the current frame differs from the prior frame by less than the movement threshold.

15. A system for focusing a digital camera, the system comprising:
a differencer configured to difference a current frame and a prior frame to produce a frame difference;
a jitter simulator configured to jitter the current frame to produce a jitter frame and to compare the jitter frame to the current frame to produce a jitter difference; and
a comparator configured to compare the frame difference and the jitter difference and to output a movement value based on the comparison, the movement value indicating whether focusing should occur.

16. The system for focusing a digital camera in accordance with claim 16, wherein the jitter simulator is configured to jitter the current frame by shifting the current frame by a predetermined amount in a predetermined direction.

17. The system for focusing a digital camera in accordance with claim 17, wherein the jitter simulator is configured to shift the current frame by about five pixels.

18. The system for focusing a digital camera in accordance with claim 17, wherein the jitter simulator is configured to shift the current frame in a diagonal direction.

19. The system for focusing a digital camera in accordance with claim 16, wherein the comparator is configured to output a movement value indicating that focusing should occur if the frame difference is greater than the jitter difference.

20. The system for focusing a digital camera in accordance with claim 20, wherein the comparator is further configured to select an autofocus algorithm based on the extent to which the frame difference is greater than the jitter difference.
